(19) United States
(12) Patent Application Publication
(10) Pub. No.: US 2008/0082802 A1
(43) Pub. Date: Apr. 3, 2008

(54) Microcomputer debugging system

(76) Inventors: Shinya Muramatsu, Hyogo (JP); Toshifumi Hamaguchi, Osaka (JP)

Correspondence Address: MCDERMOTT WILL & EMERY LLP, 600 13TH STREET, NW, WASHINGTON, DC, 20005-3096, US

(21) Appl. No.: 11/905,228

(22) Filed: Sep. 28, 2007

(30) Foreign Application Priority Data
Sep. 29, 2006 (JP) 2006-267783

(51) Int. Cl. G06F 9/00

(52) U.S. Cl. 712/227

(57) ABSTRACT

A microcomputer debugging system capable of executing a plurality of debug modes, wherein processing is not allowed to shift to an interruption program during a debugging operation in one of the plurality of debug modes, and is allowed to shift to the interruption program during the debugging operation in another debug mode.

### BACKGROUND OF THE INVENTION

1. Field of the Invention

The present invention relates to a microcomputer debugging system and a microcomputer used for the development of software for controlling an applied system in which a microcomputer is used.

2. Description of the Related Art

As a conventional step in the development of software for controlling an applied system in which a microcomputer is used, a program is debugged. For example, Japanese Patent Laid-Open Publication No. H10-69398 of the Japanese Patent Documents recites program debugging in a DC motor control system.

FIG. 8 is a block diagram of a DC motor control system. In this system, aport output of a microcomputer 100 is connected to an input of a motor control circuit 101, and an output of the motor control circuit 101 is supplied to a DC motor 102 in order to supply power, wherein an interruption request is generated at certain intervals with a timer 103, and the port output is changed based on an interruption processing routine.

Referring to a timing chart shown in FIG. 9, the debugging operation of user programs (hereinafter, referred to as programs) in the DC motor control system is described. A microcomputer 100 comprises a plurality of user levels, which denote priority levels when the programs are processed, wherein the program whose urgency is low is executed at a user level 1, and the program whose urgency is high is executed at a user level 0. In the example shown in FIG. 8, the program of great urgency for controlling the DC motor 102 is executed by the interruption processing at the user level 0. In FIG. 9, when a debug request is generated in the state where the program whose urgency is low is executed at the user level 1 (110 in the drawing), the processing unconditionally shifts to a debug level because the debug level is prioritized over the user level 1, and the program is debugged. When the interruption program whose urgency is high at the user level 0 which is prioritized over the debug level is requested while the program is being debugged (111 in the drawing), the debug is temporarily stopped, the processing shifts to the user level 0, and the execution of the interruption program starts. When the processing of the interruption program is completed (112 shown in the drawing), the processing returns to the debug level, and the debug restarts. When the debug is completed (113 in the drawing), the processing returns to the user level 1, and the program whose urgency is low is executed.

In the conventional debugging operation, it is possible to execute the program whose urgency is high at the user level 0 during the debugging operation. However, the processing unconditionally shifts to the debug level when the debug is requested while the program whose urgency is high is being executed.

Therefore, in the example shown in FIG. 8, when the debug is requested, the program of great urgency for controlling the DC motor 102 is temporarily stopped. As a result, the DC motor 102 becomes uncontrollable, which results in such a system abnormality that a motor coil is burnt off.

### SUMMARY OF THE INVENTION

Therefore, a main object of the present invention is to provide a microcomputer debugging system which can avoid any system abnormality.

A microcomputer debugging system according to the present invention is capable of executing a plurality of debug modes, wherein processing is not allowed to shift to an interruption program during debugging operation in one of the plurality of debug modes, and is allowed to shift to the interruption program during the debugging operation in another debug mode.

When the present invention is applied to a DC motor control system, for example, one of the debug modes is executed so that a program whose urgency is high is debugged in a state where the DC motor is not connected, while another debug mode is executed so that the whole system other than the program whose urgency is high is debugged in a state where the DC motor is connected. As a result, the halt of the DC motor control program whose urgency is high is prevented.

The microcomputer debugging system according to the present invention preferably comprises:

a CPU capable of executing the plurality of debug modes;

a priority allowing flag for controlling a period during which the processing of the interruption program is accepted during the debugging operation; and

a debug judging circuit for not allowing the CPU to shift to the interruption program during the debugging operation in one of the debug modes described above and allowing the CPU to shift to the interruption program during the debugging operation in another debug mode described above in the period during which the processing of the interruption program is accepted set by the priority allowing flag.

Accordingly, a period during which the halt of the debug program does not cause any problem is set by the priority allowing flag when the whole system other than the program whose urgency is high is debugged by another debug mode. As a result, the interruption program can be processed during the period.

The microcomputer debugging system according to the present invention preferably further comprises a level setting register for setting priority levels with respect to a plurality of interruption programs proposed during the debugging operation, wherein

the processing of the interruption program can be accepted in a multiple manner during the debugging operation based on the priority levels set by the level setting register.

Accordingly, the program processing can be achieved in the multiple manner during the debugging operation.

A microcomputer according to the present invention comprises the foregoing microcomputer debugging system and a debug request control circuit, wherein

the debug request control circuit outputs a debug request to the debug judging circuit, and

the CPU, the debug judging circuit, the priority allowing flag and the debug request control circuit are preferably mounted in a one-chip structure.

A microcomputer according to the present invention comprises the foregoing microcomputer debugging system and a debug request control circuit, wherein

the debug request control circuit outputs a debug request to the debug judging circuit, and

the CPU, the debug judging circuit, the priority allowing flag, the level setting register and the debug request control circuit are preferably mounted in a one-chip structure.

According to the foregoing preferable constitutions, the system externally mounted can be simplified, and required resources can be reduced to minimum. As a result, downsizing and cost reduction can be achieved.

The present invention can avoid such a system abnormality that the program of great urgency for controlling the DC motor is temporarily stopped due to the generation of the debug request, which makes the DC motor uncontrollable, and a motor coil is thereby burned off.

The present invention is useful for a system for controlling a DC motor using a microcomputer.

### BRIEF DESCRIPTION OF THE DRAWINGS

These and other objects of the present invention will become clear by the following description of preferred embodiments of the invention and they will be specified in the claims attached hereto. A number of benefits not recited in this specification will come to the attention of the skilled in the art upon the implementation of the present invention.

FIG. 1 is a block diagram of a microcomputer debugging system according to a preferred embodiment 1 of the present invention.

FIG. 2 is a timing chart of the debugging operation by the microcomputer debugging system according to the preferred embodiment 1.

FIG. 3 is another timing chart of the debugging operation by the microcomputer debugging system according to the preferred embodiment 1.

FIG. 4 is a block diagram of a microcomputer debugging system according to a preferred embodiment 2 of the present invention.

FIG. 5 is a timing chart of the debugging operation by the microcomputer debugging system according to the preferred embodiment 2.

FIG. 6 is a block diagram of a microcomputer debugging system according to a preferred embodiment 3 of the present invention.

FIG. 7 is a block diagram of a microcomputer debugging system according to a preferred embodiment 4 of the present invention.

FIG. 8 is a block diagram of a DC motor control system in which a microcomputer is used.

FIG. 9 is a timing chart of conventional debugging operation.

### DETAILED DESCRIPTION OF THE INVENTION

### Preferred Embodiment 1

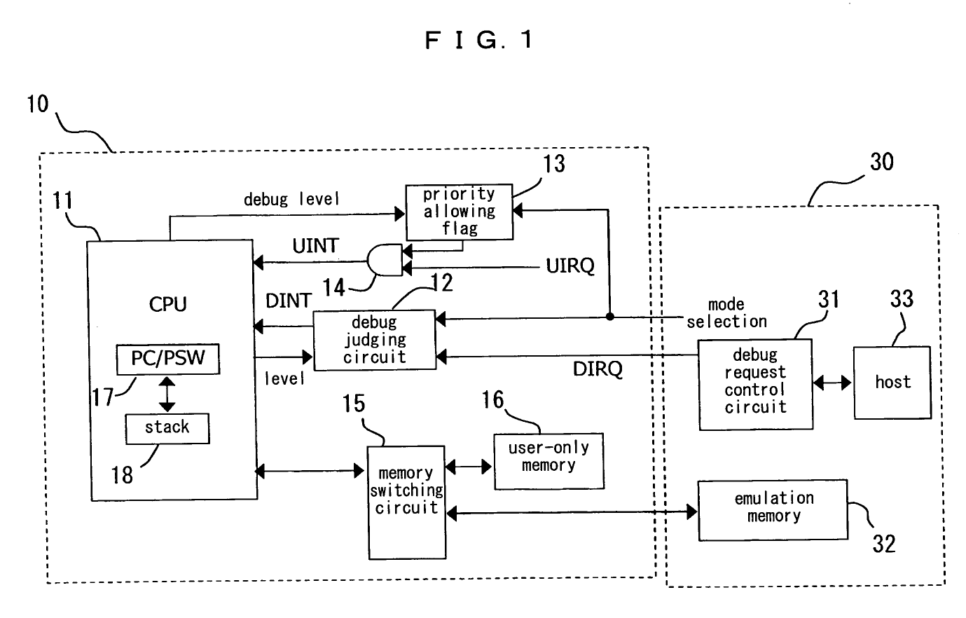

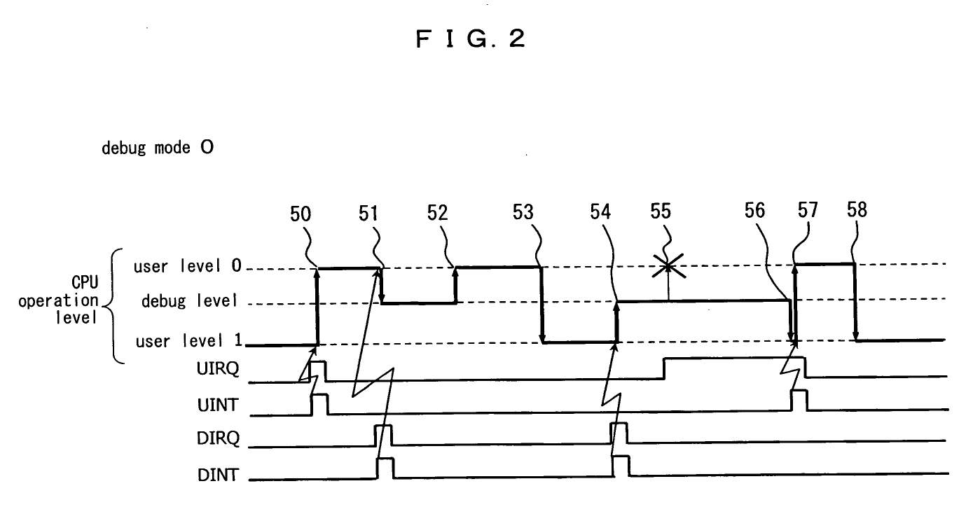

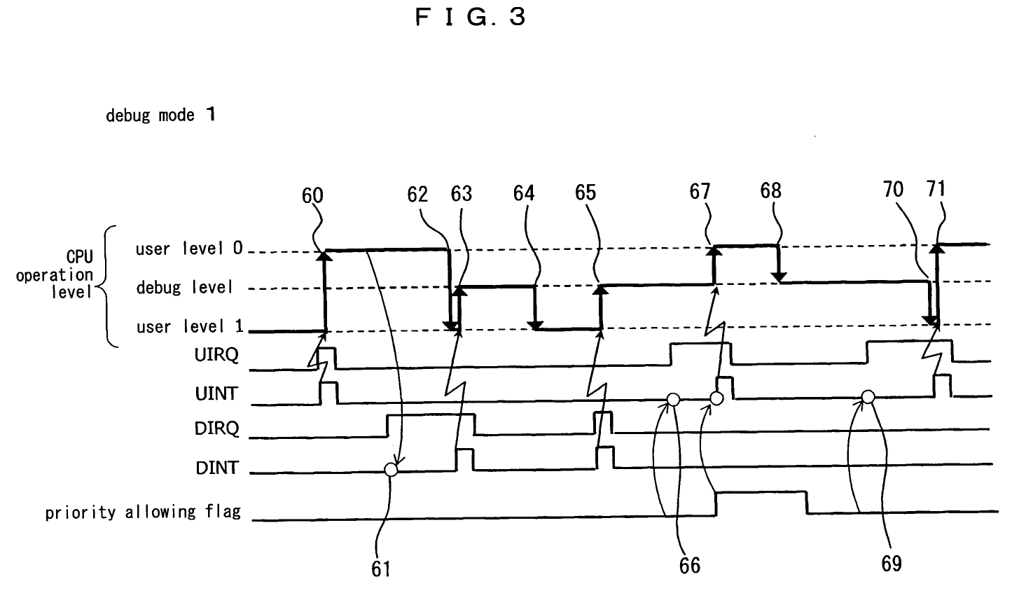

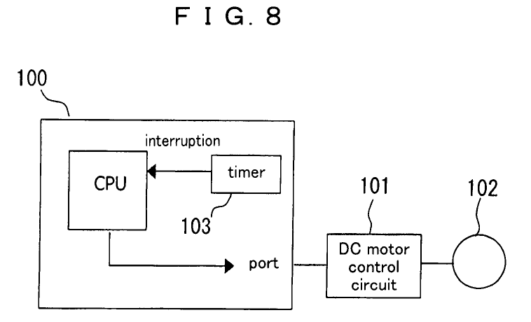

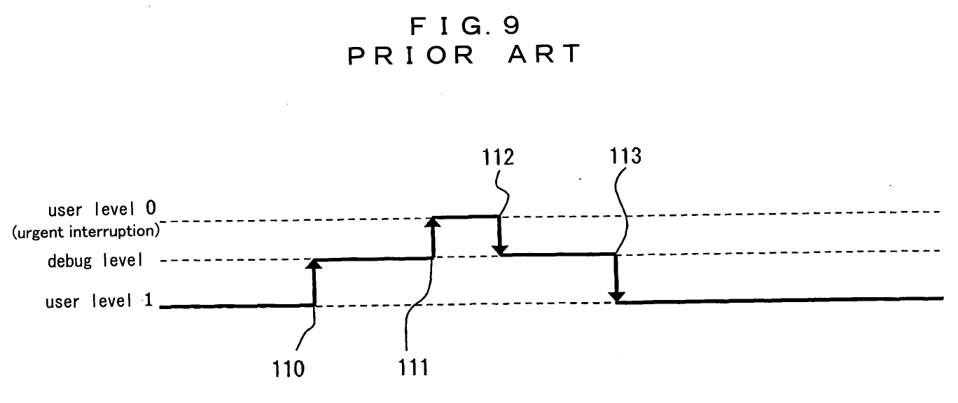

A preferred embodiment 1 of the present invention is described referring to FIGS. 1-3. FIG. 1 is a block diagram of a microcomputer debugging system according to the present preferred embodiment. FIGS. 2 and 3 are timing charts of the debugging operation by the microcomputer debugging system. The microcomputer debugging system according to the present preferred embodiment is suitably applied to a DC motor control system in which the microcomputer shown in FIG. 8 is used. Below is described a constitution of the microcomputer debugging system referring to FIG. 1.

Roughly describing the constitution of the microcomputer debugging system, a controller 10 for controlling the DC motor and a debugger 30 for debugging programs in the DC motor control system are provided. The controller 10 has such a structure that all of electronic components shown in the drawing are housed in a one-chip microcomputer and mounted on a substrate or a such a structure that a part of the electronic components are housed in the microcomputer and the rest of the electronic components are mounted on the substrate together with the microcomputer. The debugger 30 has a structure where the electronic components except for a host 33 in the drawing are mounted on the substrate. Therefore, in the structure of the microcomputer debugging system comprising the controller 10 and the debugger 30, the microcomputer and the electronic components, except for the host 33, are mounted on the substrate.

The controller 10 comprises a CPU 11, a debug judging circuit 12, a priority allowing flag 13, an AND circuit 14, a memory switching circuit 15 and a user-only memory 16. The debugger 30 comprises a debug request control circuit 31, an emulation memory 32 and the host 33.

First, the respective components of the controller 10 are described in detail. The CPU 11 comprises a program counter/program status word (hereinafter, referred to as PC/PSW) 17, and a stack 18 in which the PC/PSW 17 is saved when an interruption is generated. The CPU 11 outputs a level signal to the debug judging circuit 12, and a DINT signal is inputted from the debug judging circuit 12 to the CPU 11. The level signal is a signal showing a user level which is a priority level when the programs are processed, and the DINT signal is a signal which orders the execution of the debug. The CPU 11 according to the present preferred embodiment comprises three levels in total, which are two user levels 0 and 1, and a debug level. Mentioning them from the higher priority level, the user level 0 used when the program whose priority is high is processed comes first and is followed by the user level 1 used when the ordinary program is processed; but the priority order between the debug level and the user level changes depending on a debug mode. When the interruption request at the user level 0 is generated in a state of the user level 1: the PC/PSW at the user level 1 is saved in the stack 18; and the CPU 11 is changed to the user level 0. Then, the interruption program at the user level 0 is processed by the CPU 11. Further, the CPU 11 outputs a debug level signal to the priority allowing flag 13, and a UINT signal is inputted from the AND circuit 14 to the CPU 11. The debug level signal is a signal for notifying the execution of the debug program, and the UINT signal is a signal for ordering the execution of the interruption program.

The CPU 11 further outputs an address of the program to be accessed to the memory switching circuit 15. This processing is necessary for indicating which of the programs memorized in the memories 16 and 32 is to be accessed.

A mode selection signal from the debugger 30, a DIRQ signal from the debug request control circuit 31 and the above-described level signal from the CPU 11 are inputted to the debug judging circuit 12. The debug judging circuit 12 outputs the DINT signal to the CPU 11.

The mode selection signal is a signal for selecting the debug mode, and a debug mode 0 is set therein in the case where the DC motor is not connected, and a debug mode 1 is set therein in the case where the DC motor is connected.

ADIRQ signal is a signal for requesting the debug. When the DIRQ signal is in the debug mode 0, the debug judging circuit 12 outputs the DINT signal for making the CPU 11 execute the debug. When the DIRQ signal is in the debug mode 1, the debug judging circuit 12 sets the DINT signal based on the level signal received from the CPU 11 in such a manner that the DINT signal for executing the debug is outputted when the level signal is at the user level 1, and the DINT signal is not outputted when the level signal is at the user level 0.

The priority allowing flag 13 outputs a priority allowing flag signal to the AND circuit 14 when the mode selection signal from the debugger 30 and the debug level signal from the CPU 11 are inputted. The priority allowing flag signal is characterized as follows. The priority allowing flag signal is a signal for judging whether or not the interruption program is executed during the execution of the debug program. A zone which allows the interruption is set therein in the case of the debug mode 1, and the priority allowing flag signal in the zone is at “H” level which allows the execution of the interruption program. In the case of the debug mode 0, the zone which allows the interruption is not set therein, and the priority allowing flag signal is at “L“ level which rejects the execution of the interruption program during an entire period during which the debug program is executed.

Below is described how the priority allowing flag 13 is necessary. When the interruption request is generated during the execution of the debug program, processing for displaying internal information of the CPU 11 (contents of the register and setting the status of peripheral circuits) by the host 33 is being executed. Therefore, the interruption whose urgency is high is generated, and the contents to be displayed by the host 33 may go wrong when the processing of the debug program is temporarily stopped. Therefore, the priority allowing flag 13 is necessary in order to set such a period that the halt of the debug program does not cause any problem.

A UIRQ signal, and the priority allowing flag signal from the priority allowing flag 13 are inputted to the AND circuit 14, and the AND circuit 14 outputs the UINT signal to the CPU 11. The UIRQ signal is a signal for requesting the interruption of the program whose urgency is high, and the AND circuit 14 outputs the UINT signal based on the AND judgment between the UIRQ signal and the priority allowing flag signal. While the debug program is not being executed, the AND circuit 14 outputs the UIRQ signal directly as the UINT signal.

The address of the program to be accessed is inputted from the CPU 11 to the memory switching circuit 15, and one of the program memorized in the user-only memory 16 and the program memorized in the emulation memory 32, which corresponds to the address, is executed.

The user-only memory 16 memorizes therein the various programs in the DC motor control system, which includes programs of great urgency for controlling the DC motor.

Next, the respective components of the debugger 30 are described in detail. The debug request control circuit 31 exchanges various kinds of information such as the debug request and the state of progress with the host 33. The debug request control circuit 31 outputs the DIRQ signal to the debug judging circuit 12 based on the request from the host 33 and conditions set by the CPU operation.

The debug program is memorized in the emulation memory 32. All of the contents of the user-only memory 16 may be memorized in the emulation memory 32 so that all of the programs used by a user can be executed via the emulation memory 32.

A personal computer constitutes the host 33. The various kinds of information such as the debug request and the state of progress is inputted and outputted between the host 33 and the debug request control circuit 31. The information such as the state of progress of the debug is displayed on a display of the host 33.

Next, the debugging operation of the microcomputer debugging system is described referring to FIGS. 2 and 3. FIG. 2 is a timing chart of the debugging operation in the case where the debug mode 0 is selected in the selection of the debug mode. FIG. 3 is a timing chart of the debugging operation in the case where the debug mode 1 is selected in the selection of the debug mode.

First is described the case where the debug mode 0 is selected. The debug mode 0 denotes the state where the DC motor is not connected to the microcomputer debugging system, which corresponds to such a case that the program is debugged when the DC motor is not connected yet in a stage where the DC motor is being manufactured. When the debug mode 0 is selected, the debug level is prioritized over the user levels 0 and 1.

When the interruption of the program whose urgency is high at the user level 0 is requested while the program whose urgency is low at the user level 1 is being executed by the CPU 11, the UIRQ signal becomes “H”. At the time, the UIRQ signal is directly outputted as the UINT signal from the AND circuit 14 because no debug program is being executed in the CPU 11. Therefore, the interruption program whose urgency is high at the user level 0 is executed by the CPU 11 (50 in the drawing).

When the debug is requested, the DIRQ signal is inputted to the debug judging circuit 12. Because the debug mode is the debug mode 0 at the time, the debug judging circuit 12 outputs the DINT signal for making the CPU 11 execute the debug in response to the DIRQ signal to the CPU 11. As a result, the CPU 11 shifts to the debug level of the highest priority and executes the debug program (51 in the drawing).

When the debug is completed, the CPU 11 returns to the user level 0 and executes the interruption program whose urgency is high (52 in the drawing). When the execution of the interruption program by the CPU 11 is completed, the CPU 11 returns to the user level 1 and executes the program whose urgency is low (53 in the drawing). When the debug is requested while the program whose urgency is low at the user level 1 is being executed by the CPU 11, the DIRQ signal is inputted from the debug request control circuit 31 to the debug judging circuit 12. Because the debug mode is the debug mode 0 at the time, the DINT signal for making the CPU 11 execute the debug in response to the DIRQ signal is outputted to the CPU 11. Therefore, the CPU 11 shifts to the debug level of the highest priority and executes the debug program (54 in the drawing).

When the interruption of the program whose urgency is high at the user level 0 is requested while the debug is being executed by the CPU 11, the UIRQ signal becomes “H”. Because the debug mode is the debug mode 0 then, the priority allowing flag signal from the priority allowing flag 13 becomes “L” during the execution of the debug program. Therefore, the UINT signal is not outputted from the AND circuit 14, and the interruption program is not executed by the CPU 11 (55 in the drawing). Then, the CPU 11 returns to the user level 1 after the completion of the debug and executes the program whose urgency is low (56 in the drawing). At that time, the execution of the debug program has been completed and thereby the AND circuit 14 has outputted the UINT signal based on the UIRQ signal, and therefore the CPU 11 executes the interruption program whose urgency is high at the user level 0 (57 in the drawing). When the execution of the interruption program by the CPU 11 is completed, the CPU 11 returns to the user level 1 and executes the program whose urgency is low (58 in the drawing).

Next is described the case of the debug mode 1 referring to FIG. 3. The debug mode 1 corresponds to such a case that the program is debugged in the state where DC motor is connected in a manufacturing state or such a case that the program is debugged in a state where the product is collected and inspected due to some kind of trouble. When the interruption of the program whose urgency is high at the user level 0 is requested while the program whose urgency is low at the user level 1 is being executed, the UIRQ signal becomes “H”. Because the debug program is not being executed by the CPU 11 at the time, the AND circuit 14 directly outputs the UIRQ signal as the UINT signal. As a result, the CPU 11 executes the interruption program whose urgency is high at the user level 0 (60 in the drawing).

When the debug is requested in this state, the DIRQ signal is inputted to the debug judging circuit 12. Because the debug mode is the debug mode 1 then, the debug judging circuit 12 makes reference to the level signal received from the CPU 11. The reference result then shows the user level 0. Therefore, the debug judging circuit 12 does not output the DINT signal to the CPU 11, and the CPU 11 does not execute the debug program (61 in the drawing). When the execution of the interruption program is completed, the CPU 11 returns to the user level 1 and executes the program whose urgency is low (62 in the drawing). At the time, the DIRQ signal remains inputted to the debug judging circuit 12, and therefore, the debug judging circuit 12 makes reference to the level signal received from the CPU 11. Because the reference result then shows the user level 1, the debug judging circuit 12 outputs the DINT signal for making the CPU 11 execute the debug. As a result, the CPU 11 shifts to the debug level and executes the debug program (63 in the drawing).

After the debug is completed, the CPU 11 returns to the user level 1 and executes the program whose urgency is low (64 in the drawing). When the debug is requested while the program whose urgency is low at the user level 1 is being executed, the DIRQ signal is inputted to the debug judging circuit 12. Because the debug mode is the debug mode 1 at the time, the debug judging circuit 12 makes reference to the level signal received from the CPU 11. Because the reference result then shows the user level 1, the debug judging circuit 12 outputs the DINT signal for making the CPU 11 execute the debug to the CPU 11. Therefore, the CPU 11 shifts to the debug level and executes the debug program (65 in the drawing).

When the interruption of the program whose urgency is high at the user level 0 is requested during the execution of the debug, the UIRQ signal becomes “H”. Further, the priority allowing flag signal from the priority allowing flag 13 becomes “L” because a setting is not made to preferentially allow the execution of the interruption program whose urgency is high in the debug mode 1 then. Therefore, the AND circuit 14 does not output the UINT signal. As a result, the CPU 11 does not execute the interruption program whose urgency is high at the user level 0 (66 in the drawing).

Because a setting is not made at the time to preferentially allow the execution of the interruption program whose urgency is high, the priority allowing flag signal from the priority allowing flag 13 becomes “H”. Therefore, the AND circuit 14 outputs the UINT signal in response to “H” of the UIRQ signal. As a result, the CPU 11 temporarily stops the debug program and executes the interruption program whose urgency is high at the user level 0 (67 in the drawing).

When the execution of the interruption program is completed, the CPU 11 returns to the debug level and executes the debug program (68 in the drawing). Because a setting is not made to preferentially allow the execution of the interruption program whose urgency is high in the debug mode 1, the priority allowing flag signal from the priority allowing flag 13 becomes “L” though the interruption of the program whose urgency is high at the user level 0 is requested while the debug is being executed. Therefore, the AND circuit 14 does not output the UINT signal, and accordingly, the CPU 11 does not execute the interruption program (69 in the drawing). When the debug is completed, the CPU 11 returns to the user level 1 and executes the program whose urgency is low (70 in the drawing). At the time, the UIRQ signal is “H”, and the debug program is not being executed by the CPU 11. Therefore, the AND circuit 14 directly outputs the UIRQ signal as the UINT signal. As a result, the CPU 11 executes the interruption program whose urgency is high at the user level 0 (71 in the drawing).

According to the microcomputer debugging system thus constituted, the program whose urgency is high is debugged in the debug mode 0 in the state where the DC motor is not connected, while the whole system except for the program whose urgency is high can be debugged in the debug mode 1 in the state where the DC motor is connected. As a result, it can be avoided to temporarily stop the DC motor control program whose urgency is high, and such a system abnormality that the DC motor becomes uncontrollable and the motor coil is burnt off, can be avoided.

When the whole system except for the program whose urgency is high is debugged in the debug mode 1, the period during which the debug program is halted by the priority allowing flag 13 so that the interruption program is processed may be limited. As a result, the debug program can be simplified, and the debug system which does not generate any error in the debug information displayed by the host can be provided.

### Preferred Embodiment 2

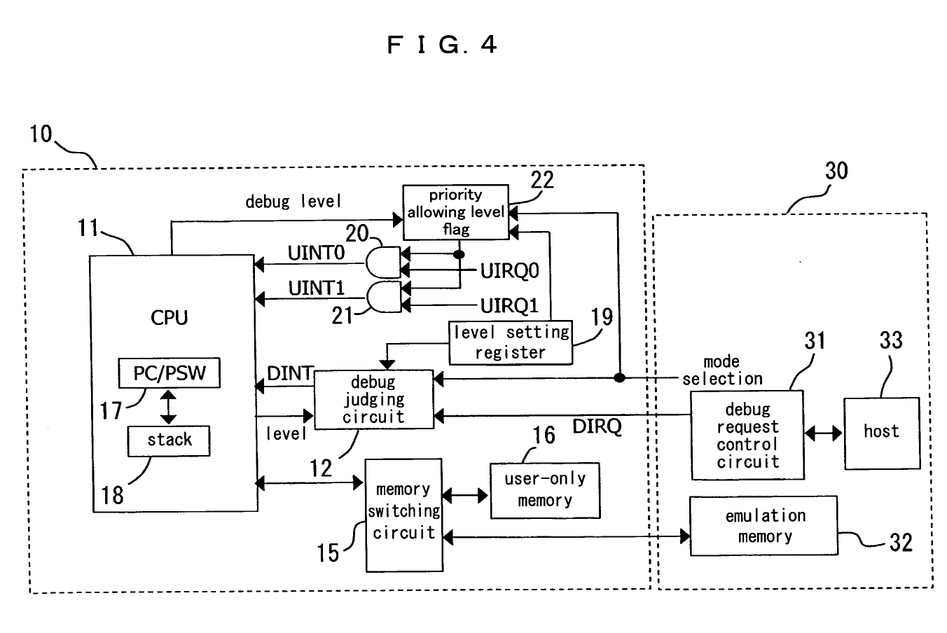

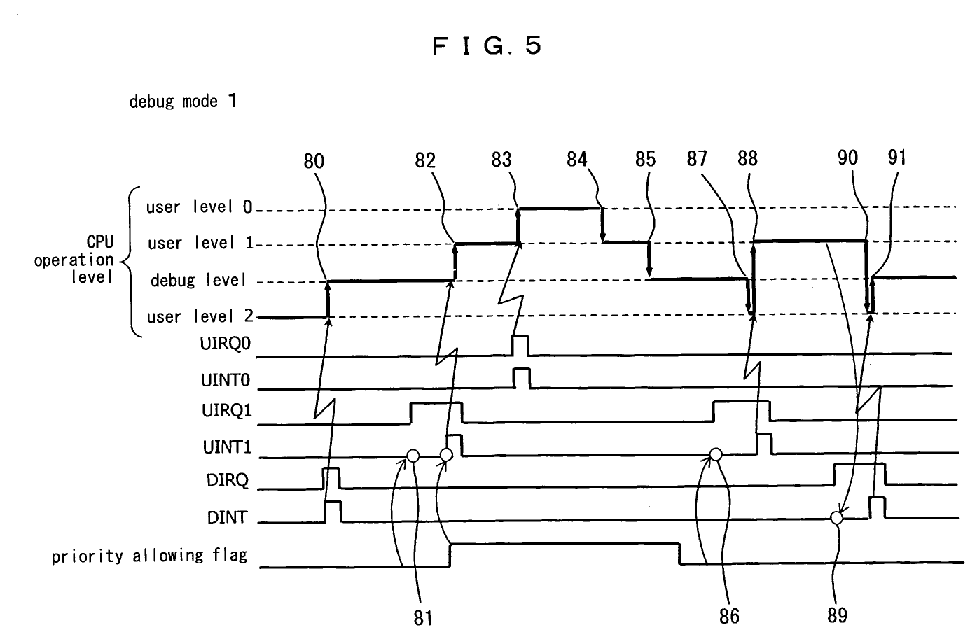

A preferred embodiment 2 of the present invention is described referring to FIGS. 4 and 5. FIG. 4 is a block diagram of a microcomputer debugging system according to the present preferred embodiment, and FIG. 5 is a timing chart of the debugging operation in the microcomputer debugging system. The same components as those according to the preferred embodiment 1 are provided with the same reference symbols and are not redundantly described.

The present preferred embodiment is different to the preferred embodiment 1 in that a level setting register 19 and two AND circuits 20 and 21 are further provided, and the priority allowing flag 13 is replaced with a priority allowing level flag 22. Further, the CPU 11 comprises four levels, which are three user levels 0, 1 and 2, and a debug level.

The level setting register 19 sets priority levels between the there user levels 0, 1 and 2, and the debug level, in other words, sets the user levels to be prioritized over the debug level. A level 1, which denotes that the user levels 0 and 1 are prioritized over the debug level, is set in the level setting register 19 in the present preferred embodiment.

The AND circuit 20 outputs a UINT0 signal based on the AND judgment between a UIRQ0 signal and a priority allowing level flag signal (inputted from the priority allowing level flag 22). The AND circuit 21 outputs a UINT1 signal based on the AND judgment between a UIRQ1 signal and the priority allowing level flag signal (inputted from the priority allowing level flag 22).

To the priority allowing level flag 22 are supplied a mode selection signal, a debug level signal and a user level signal. The debug level signal is supplied from the CPU 11. The user level signal is a signal which shows the user level to be prioritized over the debug level, and is supplied from the level setting register 19. The priority allowing level flag 22 generates the priority allowing level flag signal based on the supplied signals and outputs the generated signal to the AND circuits 20 and 21.

Next, the debugging operation of the microcomputer debugging system according to the present preferred embodiment is described referring to FIG. 5. FIG. 5 is a timing chart in the state where the debug mode 1 is selected (state where the DC motor is connected) in the mode selection. The operation in the state where the debug mode 0 is selected in the mode selection, in which the debug is preferentially executed, is not particularly different to that of the preferred embodiment 1, and therefore, is not described again.

When the debug is requested while the program whose urgency is low at the user level 2 is being executed, the DIRQ signal is inputted to the debug judging circuit 12. Because the debug mode is the debug mode 1 at the time, the debug judging circuit 12 makes reference to the level signal received from the CPU 11. Because the reference result then shows the user level 2, the debug judging circuit 12 outputs the DINT signal for making the CPU 11 execute the debug to the CPU 11. As a result, the CPU 11 shifts to the debug level and executes the debug program (80 in the drawing).

When the interruption of the program whose urgency is high at the user level 1 is requested during the execution of the debug by the CPU 11, the UIRQ1 signal becomes “H”. Further, the value of the level setting register is 1 in the debug mode 1; however, a setting is not made to preferentially allow the execution of the program whose urgency is high. Based on the foregoing conditions, the priority allowing level flag 22 sets the priority allowing level flag signal to “L”. Therefore, the AND circuit 21 does not output the UINT1 signal to the CPU 11, and the CPU 11 does not execute the interruption program whose urgency is high at the user level 1.

When a setting is made to preferentially allow the execution of the interruption program whose urgency is high, the priority allowing level flag signal from the priority allowing level flag 22 becomes “H”. Then, the AND circuit 21 outputs the UINT1 signal in response to “H” of the UIRQ1 signal. As a result, the CPU 11 temporarily stops the debug program and executes the interruption program whose urgency is high at the user level 1 (82 in the drawing).

When the interruption of the program whose urgency is higher at the user level 0 is requested while the interruption program whose urgency is high at the user level 1, the UIRQ0 signal becomes “H”. Because the priority allowing level flag signal from the priority allowing flag 22 is “H”, the AND circuit 21 outputs the inputted UIRQ0 signal as the UINT0 signal. As a result, the CPU 11 temporarily stops the program at the user level 1 and executes the interruption program whose urgency is high at the user level 0 (83 in the drawing).

After the execution of the interruption program at the user level 0 is completed, the CPU 11 returns to the user level 1 and executes the interruption program (84 in the drawing). After the execution of the interruption program at the user level 1 is completed, the CPU 11 returns to the debug level and executes the debug program (85 in the drawing).

When the interruption of the program whose urgency is high at the user level 1 is requested during the execution of the debug, the UIRQ1 signal becomes “H”. Because a setting is not made to preferentially allow the execution of the interruption program whose urgency is high, the priority allowing level flag signal from the priority allowing level flag 22 becomes “L”. Therefore, the AND circuit 21 does not output the UINT1 signal. As a result, the CPU 11 does not execute the interruption program whose urgency is high at the user level 1 (86 in the drawing).

When the debug is completed, the CPU 11 returns to the user level 2, and executes the program whose urgency is low (87 in the drawing). Because the UIRQ1 signal is “H” and the debug program is not being executed at the time, the AND circuit 21 directly outputs the UIRQ1 signal as the UINT1 signal. Therefore, the CPU 11 executes the interruption program whose urgency is high at the user level 1 (88 in the drawing). When the debug is requested, the DIRQ signal is inputted to the debug judging circuit 12. Because the debug mode is the debug mode 1 then, the debug judging circuit 12 makes reference to the level signal received from the CPU 11. Because the reference result then shows the user level 1, the debug judging circuit 12 does not output the DINT signal. As a result, the CPU 11 does not execute the debug program (89 in the drawing).

When the execution of the interruption program at the user level 1 is completed, the CPU 11 returns to the user level 2 and executes the program whose urgency is low (90 in the drawing) Because the DIRQ signal remains inputted to the debug judging circuit 12, the debug judging circuit 12 makes reference to the level signal received from the CPU 11. Because the reference result then shows the user level 2, the debug judging circuit 12 outputs the DINT signal for making the CPU 11 execute the debug to the CPU 11. The CPU 11 shifts to the debug level and executes the debug program (91 in the drawing).

According to the microcomputer debugging system thus constituted, such a system abnormality that the DC motor becomes uncontrollable and the motor coil is burnt off, can be avoided even in the case where there is a plurality of programs of great urgency for controlling the DC motor.

### Preferred Embodiment 3

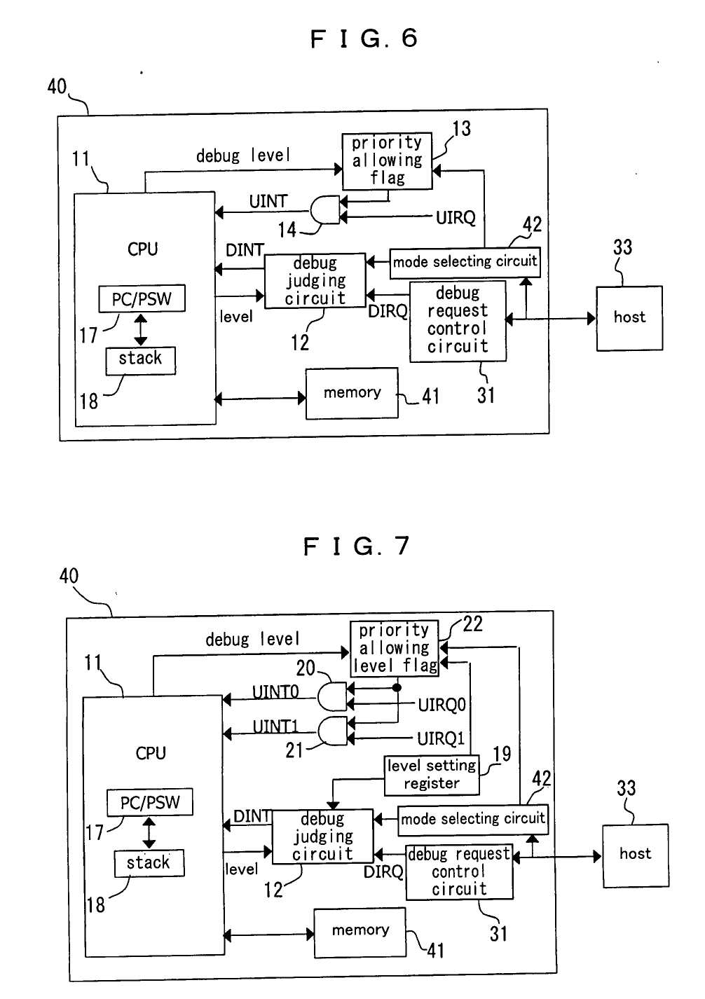

A preferred embodiment 3 of the present invention is described referring to FIG. 6. FIG. 6 is a block diagram of a microcomputer debugging system according to the present preferred embodiment. The same components as those according to the preferred embodiment 1 are provided with the same reference symbols and are not redundantly described.

According to the present preferred embodiment, the controller 10 and the debugger 30 except for the host 33 according to the preferred embodiment 1 are housed in a one-chip microcomputer 40. The debugging operation of the one-chip debugger is similar to that of the preferred embodiment 1.

According to the microcomputer debugging system thus constituted, an effect similar to that of the preferred embodiment 1 can be obtained. Further, downsizing and cost reduction can be achieved because all of the electronic components except for the host 33 are housed in the one-chip microcomputer 40.

### Preferred Embodiment 4

A preferred embodiment 4 of the present invention is described referring to FIG. 7. FIG. 7 is a block diagram of a microcomputer debugging system according to the present preferred embodiment. The same components as those according to the preferred embodiment 2 are provided with the same reference symbols and are not redundantly described.

According to the present preferred embodiment, the controller 10 and the debugger 30 except for the host 33 according to the preferred embodiment 2 are housed in a one-chip microcomputer 40. The debugging operation of the one-chip debugger is similar to that of the preferred embodiment 2.

According to the microcomputer debugging system thus constituted, an effect similar to that of the preferred embodiment 2 can be obtained. Further, downsizing and cost reduction can be achieved because all of the electronic components except for the host 33 are housed in the one-chip microcomputer 40.

In the microcomputer debugging system according to the present invention, at least the three levels in total, which are the user levels 0 and 1 and the debug level are preferably provided as the user levels settable by the CPU 11, and the number of the levels may be unlimitedly increased. The stack for saving the PC/PSW 17 when the interruption is generated may not need to be provided in the CPU 11, and a system where the PC/PSW 17 is saved in another memory means may be used. It is needless to say that the microcomputer debugging system according to the present invention can be applied to any system other than the DC motor control system.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A microcomputer debugging system capable of executing a plurality of debug modes, wherein
processing is not allowed to shift to an interruption program during debugging operation in one of the plurality of debug modes, and is allowed to shift to the interruption program during the debugging operation in another debug mode.

2. The microcomputer debugging system as claimed in claim 1, comprising:
a CPU capable of executing the plurality of debug modes;
a priority allowing flag for controlling a period during which the processing of the interruption program is accepted during the debugging operation; and
a debug judging circuit for not allowing the CPU to shift to the interruption program during the debugging operation in one of the debug modes described above and allowing the CPU to shift to the interruption program during the debugging operation in another debug mode described above in the period during which the processing of the interruption program is accepted set by the priority allowing flag.

3. The microcomputer debugging system as claimed in claim 2, further comprising a level setting register for setting priority levels with respect to a plurality of interruption programs proposed during the debugging operation, wherein
the processing of the interruption program can be accepted in a multiple manner during the debugging operation based on the priority levels set by the level setting register.

4. A microcomputer comprising the microcomputer debugging system claimed in claim 2 and a debug request control circuit, wherein
the debug request control circuit outputs a debug request to the debug judging circuit, and
the CPU, the debug judging circuit, the priority allowing flag and the debug request control circuit are mounted in a one-chip structure.

5. A microcomputer comprising the microcomputer debugging system claimed in claim 3 and a debug request control circuit, wherein
the debug request control circuit outputs a debug request to the debug judging circuit, and
the CPU, the debug judging circuit, the priority allowing flag, the level setting register and the debug request control circuit are mounted in a one-chip structure.
